(19) United States
(12) Patent Application Publication
(10) Pub. No.: US 2023/0067711 A1
(43) Pub. Date: Mar. 2, 2023

(54) LAMINATING AUXILIARY JIG FOR MULTILAYER COMPOSITE MATERIAL AND METHOD OF USING THE SAME

(71) Applicant: DAH SHENG CHEMICAL INDUSTRY CO., LTD., Taichung City (TW)

(72) Inventors: Heng-Tai CHANG, TAICHUNG CITY (TW); Yu-Che SHEN, TAICHUNG CITY (TW); Thi Bich Van CHUNG, TAICHUNG CITY (TW)

(21) Appl. No.: 17/491,640

(22) Filed: Oct. 1, 2021

(30) Foreign Application Priority Data
Aug. 31, 2021 (TW) 110132335

(51) Int. Cl. B29C 43/20; B29C 65/48; B29C 70/46

(52) U.S. Cl. CPC B29C 43/206; B29C 65/48; B29C 70/46

(57) ABSTRACT

A laminating auxiliary jig includes a base having an accommodating recess, and a pressing plate pivotably attached to the base and having a positioning trough. When the pressing plate is opened, it is separated from the accommodating recess, which a first composite material is put into. When the pressing plate is closed, it is located in the accommodating recess and pressed on the first composite material, the positioning trough communicates with the accommodating recess, and at least one middle foam material is put into the positioning trough to be positioned and attached to the first composite material. When the pressing plate is opened again, a second composite material is put into the accommodating recess to be attached to the middle foam material. Therefore, the laminating auxiliary jig helps a user quickly complete laminating the multilayer composite material. The method of using the laminating auxiliary jig is also provided.

### BACKGROUND OF THE INVENTION

### 1. Field of the Invention

The present invention relates to the laminating technology of multilayer composite materials and more particularly, to a laminating auxiliary jig for a multilayer composite material, and a method of using the laminating auxiliary jig.

### 2. Description of the Related Art

For the multilayer composite materials used in shoes, the traditional manufacturing method is to wrap a middle material, such as cardboard, between two surface materials, such as foam, in a sewing manner, and then perform subsequent processing. However, the above-described method consumes too much time, resulting in poor processing efficiency. If it is changed to perform the fixing in an adhesive manner, deviation is liable to occur in the alignment, which will affect the yield of the finished product. Therefore, the traditional manners for manufacturing multilayer composite materials still need improvement.

### SUMMARY OF THE INVENTION

It is a primary objective of the present invention to provide a laminating auxiliary jig for a multilayer composite material, which can help a user quickly complete laminating a multilayer composite material, so as to improve processing efficiency.

To attain the above primary objective, the laminating auxiliary jig of the present invention includes a base and a pressing plate. The top surface of the base has an accommodating recess for accommodating materials to be laminated. The pressing plate has a positioning trough for providing positioning effect. The rear side of the pressing plate is pivotably attached to the top surface of the base so that the pressing plate is pivotable upward and downward relative to the base. When the pressing plate is located at the open position, the pressing plate is separated from the accommodating recess of the base. When the pressing plate is located at the close position, the pressing plate is located in the accommodating recess of the base, and the positioning trough of the pressing plate communicates with the accommodating recess of the base.

It can be known from the above description that the laminating auxiliary jig of the present invention is used in a way that the pressing plate is firstly opened, then a first composite material is put into the accommodating recess, then the pressing plate is closed, then according to the practical requirements, at least one foam material is put into the positioning trough to be positioned and attached to the first composite material, then the pressing plate is opened, and a second composite material is put into the accommodating recess and attached to the foam material, such that a multilayer composite material is obtained. In other words, the present invention uses the simple structural combination of the base and the pressing plate to help the user quickly complete laminating the multilayer composite material, so as to improve processing efficiency.

Preferably, the contour of the accommodating recess corresponds in coordination with the contour of the pressing plate, so that the pressing plate can be positively pressed on the rim of the first composite material when located at the close position.

Preferably, the laminating auxiliary jig further includes a protruding rod. The protruding rod is provided adjacent to the front side of the pressing plate and an end of the protruding rod is fixed to the top surface of the pressing plate. When the pressing plate is located at the close position, the user can easily open the pressing plate to the open position by pulling the protruding rod.

Preferably, the base further has a first positioning protrusion. The first positioning protrusion is provided on the inner periphery of the accommodating recess for the first composite material and the second composite material to be positioned.

Preferably, the pressing plate further has a second positioning protrusion. The second positioning protrusion is provided on the inner periphery of the positioning trough for the foam material to be positioned.

Further, it is a secondary objective of the present invention to provide a method of using the aforementioned laminating auxiliary jig, which is easy in operation and can improve processing efficiency.

To attain the above secondary objective, the method of using the laminating auxiliary jig of the present invention includes the steps of: a) applying glue to the top surface of the first composite material, the top and bottom surfaces of a middle foam material and the bottom surface of the second composite material; b) opening the pressing plate to the open position and putting the first composite material into the accommodating recess of the base in a way that the top surface of the first composite material faces upward; c) closing the pressing plate to the close position to press the pressing plate on the rim of the first composite material; d) putting the middle foam material into the positioning trough of the pressing plate to stick the bottom surface of the middle foam material on the top surface of the first composite material; e) opening the pressing plate to the open position and putting the second composite material into the accommodating recess of the base to stick the bottom surface of the second composite material on the top surface of the middle foam material, thereby obtaining a multilayer composite material; and 0 taking out the multilayer composite material from the accommodating recess of the base.

It can be known from the above-described method that the present invention enables the user to quickly and conveniently complete laminating the multilayer composite material to improve processing efficiency.

Preferably, in the step a), the top and bottom surfaces of a first middle foam material and the top and bottom surfaces of a second middle foam material are applied with glue; in the step d), the first middle foam material is firstly put into the positioning trough of the pressing plate in a way that the bottom surface of the first middle foam material is sticked on the top surface of the first composite material, and then the second middle foam material is put into the positioning trough of the pressing plate in a way that the bottom surface of the second middle foam material is sticked on the top surface of the first composite material and the top surface of the first middle foam material; in the step e), the bottom surface of the second composite material is sticked on the top surface of the second middle foam material.

Preferably, in the step d), the rear side and the left and right ends of the first middle foam material are abutted against a rear portion of the positioning trough, and the front side and the left and right ends of the second middle foam material are abutted against a front portion of the positioning trough. In this way, the pressing plate provides positioning effect to the first middle foam material and the second middle foam material by the positioning trough.

Preferably, the base further has a first positioning protrusion provided on the inner periphery of the accommodating recess. The outer periphery of the first composite material has a first positioning indentation. The outer periphery of the second composite material has a second positioning indentation. In the step b), the first positioning indentation of the first composite material is engaged with the first positioning protrusion of the base, so that the first composite material is positioned after being put into the accommodating recess. In the step e), the second positioning indentation of the second composite material is engaged with the first positioning protrusion of the base, so that the second composite material is positioned after being put into the accommodating recess.

Preferably, the pressing plate further has a second positioning protrusion provided on the inner periphery of the positioning trough. The outer periphery of the second middle foam material has a third positioning indentation. In the step d), the third positioning indentation of the second middle foam material is engaged with the second positioning protrusion of the pressing plate, so that the second middle foam material is positioned after being put into the positioning trough.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view of a laminating auxiliary jig of the present invention, showing that a pressing plate is located at an open position.

FIG. 2 is another perspective view of the laminating auxiliary jig of the present invention, showing that the pressing plate is located at a close position.

FIG. 3 is a top view of the laminating auxiliary jig of the present invention, wherein the pressing plate is located at the close position.

FIG. 4A to FIG. 4B is a flow diagram of a method of using the laminating auxiliary jig of the present invention.

### DETAILED DESCRIPTION OF THE INVENTION

First of all, it is to be mentioned that throughout this specification, including the following embodiment and claims, the directional terms are all based on the direction shown in the figures. Besides, same reference numerals used in the following embodiment and the appendix drawings designate same or similar elements or the structural features thereof.

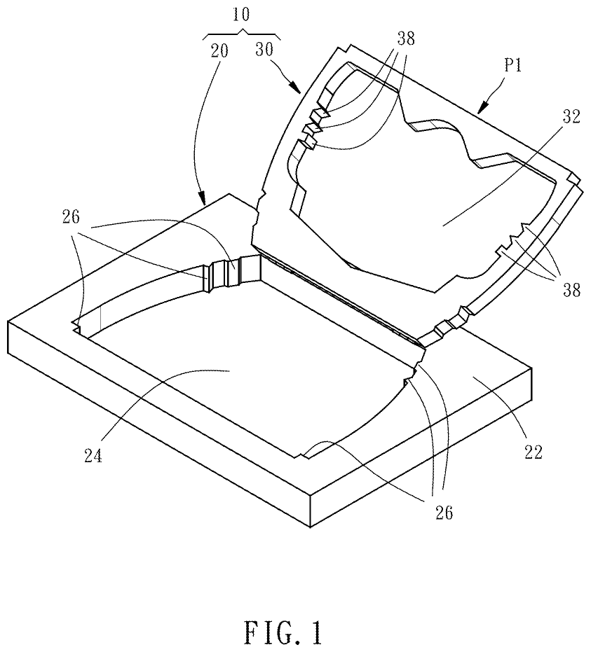

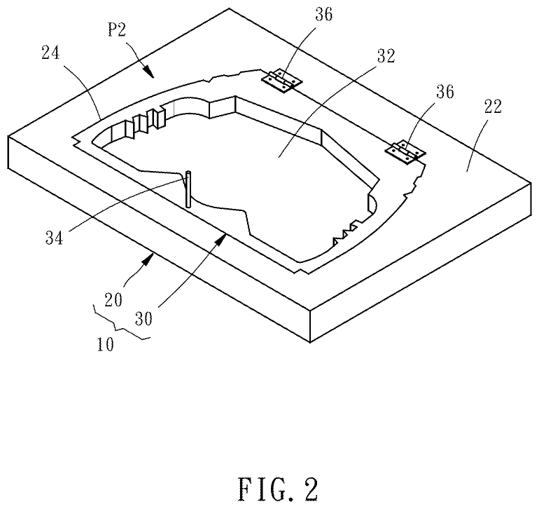

Referring to FIG. 1 and FIG. 2, the laminating auxiliary jig 10 of the present invention may, but unlimited to, be made of acrylic material, which includes a base 20 and a pressing plate 30.

The base 20 is shaped as a cuboid. The top surface 22 of the base 20 has an accommodating recess 24 for accommodating materials to be laminated. The accommodating recess 24 can be designed with various shapes according to the practical requirements, such as the shape of the material to be laminated, unlimited to the configuration shown in FIG. 1. Besides, the base 20 further has a plurality of first positioning protrusions 26. Actually, there can be at least one first positioning protrusion 26. The first positioning protrusions 26 are provided on the inner periphery of the accommodating recess 24 in a pairing manner.

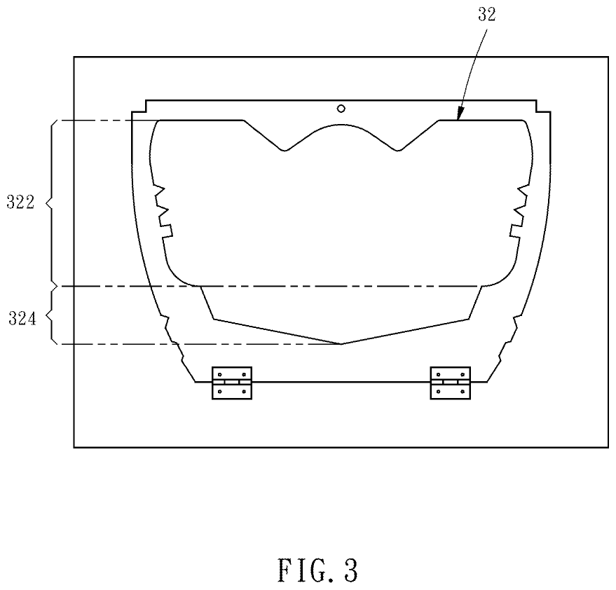

The contour of the pressing plate 30 corresponds in coordination with the contour of the accommodating recess 24. The rear side of the pressing plate 30 is pivotably attached to the top surface 22 of the base 20 by two hinges 36, so that the pressing plate 30 is pivotable upward and downward relative to the base 20 between an open position P1 as shown in FIG. 1 and a close position P2 as shown in FIG. 2. When the pressing plate 30 is located at the open position P1, the pressing plate 30 is separated from the accommodating recess 24 of the base 20. When the pressing plate 30 is located at the close position P2, the pressing plate 30 is located in the accommodating recess 24 of the base 20. Further, the pressing plate 30 has a positioning trough 32 penetrating through the top and bottom surfaces of the pressing plate 30. When the pressing plate 30 is located at the close position P2, the positioning trough 32 of the pressing plate 30 communicates with the accommodating recess 24 of the base 20. In this embodiment, as shown in FIG. 3, the positioning trough 32 is divided into a front portion 322 and a rear portion 324. A plurality of second positioning protrusions 38 arranged in a pairing manner integrally protrude from the front portion 322. Actually, there can be at least one second positioning protrusion 38. However, in practice, the positioning trough 32 can be designed with various shapes according to the practical requirements, such as the shape of the material to be laminated, unlimited to the configuration shown in FIG. 3.

As shown in FIG. 2, the present invention further provides a protruding rod 34. The protruding rod 34 is provided adjacent to the front side of the pressing plate 30, and an end of the protruding rod 34 is fixed to the top surface of the pressing plate 30. When the pressing plate 30 is located at the close position P2, a force can be applied to pull the protruding rod 34 to open the pressing plate 30 from the close position P2 to the open position P1 easily.

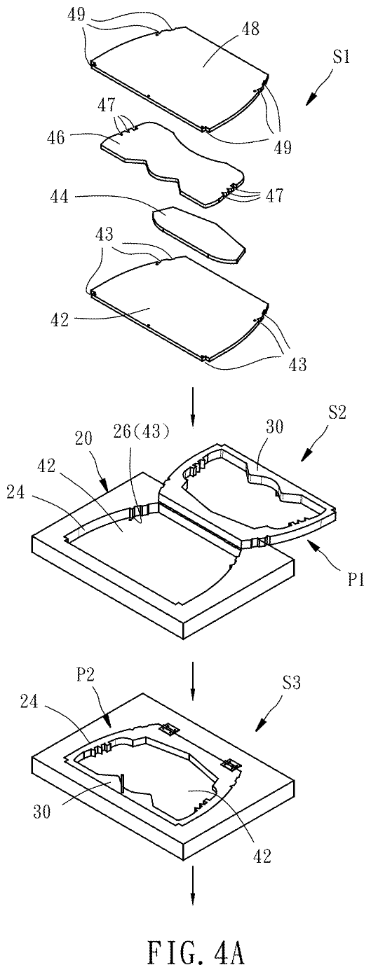

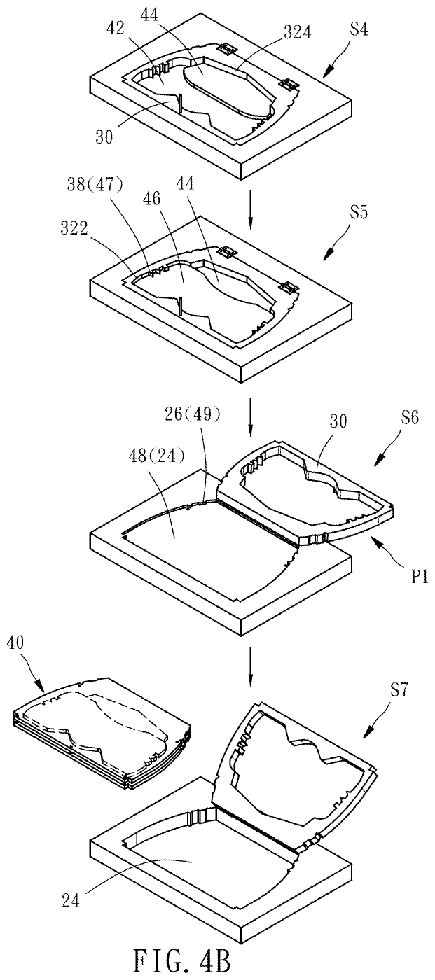

The technical features of the laminating auxiliary jig 10 of the present invention are described above. The method of using the laminating auxiliary jig 10 of the present invention will be further specified in the following. As shown in FIG. 4A and FIG. 4B, the method of using the laminating auxiliary jig 10 of the present invention includes the following steps.

a) The top surface of a first composite material 42, the top and bottom surfaces of at least one middle foam material and the bottom surface of a second composite material 48 are applied with glue.

In this embodiment, there are two middle foam materials, which are a first middle foam material 44 and a second middle foam material 46. However, in practice, the amount of the middle foam material is unlimited to two, which may be decreased to one or increased to three or more than three, depending on the practical requirements.

Secondary, the first composite material 42 may, but unlimited to, be made of Aerflex foam material provided on the bottom surface thereof with drawn-texturing yarn (DTY). The first middle foam material 44 and the second middle foam material 46 may, but unlimited to, be made of Aerflex foam material. The second composite material 48 may, but unlimited to, be made of Aerflex foam material provided on the top surface thereof with net fabric. However, actually the above-described materials can be modified according to practical requirements. Further, as the step S1 shown in FIG. 4A, before applied with glue, the first composite material 42, first middle foam material 44, second middle foam material 46 and second composite material 48 are cut with specific shapes and sizes in advance. The aforementioned shapes and sizes can be modified according to the practical requirements, unlimited to the configurations shown in FIG. 4A. In this embodiment, the contour of the first composite material 42 and the contour of the second composite material 48 both corresponds in coordination with the contour of the accommodating recess 24. The contour of the first middle foam material 44 corresponds in coordination with the contour of the rear portion 324 of the positioning trough 32. The contour of the second middle foam material 46 corresponds in coordination with the contour of the front portion 322 of the positioning trough 32.

Further, as the step S1 shown in FIG. 4A, the outer periphery of the first composite material 42 has a plurality of first positioning indentations 43 provided in a pairing manner, the outer periphery of the second composite material 48 has a plurality of second positioning indentations 49 provided in a pairing manner, and the outer periphery of the second middle foam material 46 has a plurality of third positioning indentations 47 provided in a pairing manner.

b) The pressing plate 30 is opened to the open position P1 and the first composite material 42 is put into the accommodating recess 24 of the base 20 in a way that the top surface of the first composite material 42 faces upward.

As the step S2 shown in FIG. 4A, in this step, a force is firstly applied to pull the protruding rod 34 to open the pressing plate 30 to the open position P1. Because the first composite material 42 is cut with the specific shape corresponding to the contour of the accommodating recess 24 in advance, the first composite material 42 will not be squeezed and deformed after being put into the accommodating recess 24 in the way that the top surface (the side applied with glue) of the first composite material 42 faces upward. Secondary, after the first composite material 42 is put into the accommodating recess 24, the first positioning indentations 43 of the first composite material 42 are engaged with the first positioning protrusions 26 of the base 20 respectively, which completes the positioning of the first composite material 42.

c) The pressing plate 30 is closed to the close position P2, so that the pressing plate 30 is pressed on the rim of the first composite material 42.

As the step S3 shown in FIG. 4A, in this step, because the contour of the pressing plate 30 corresponds in coordination with the contour of the accommodating recess 24, the closed pressing plate 30 can be positively pressed on the rim of the first composite material 42, which keeps the first composite material 42 flat. However, for preventing the pressing plate 30 from being sticked by the glue applied on the top surface and thereby affecting the subsequent steps, the top surface of the first composite material 42 may be reserved with a part without glue in the step a) for benefiting the pressing of the pressing plate 30.

d) The middle foam material is put into the positioning trough 32 of the pressing plate 30 in a way that the bottom surface of the middle foam material is sticked on the top surface of the first composite material 42.

In this embodiment, there are two middle foam materials, so in this step the first middle foam material 44 and the second middle foam material 46 are put into the positioning trough 32 of the pressing plate 30 in order. Further speaking, the first middle foam material 44 is firstly put into the positioning trough 32, as the step S4 shown in FIG. 4B. Because the contour of the rear portion 324 of the positioning trough 32 corresponds in coordination with the contour of the first middle foam material 44, after the first middle foam material 44 is put into the positioning trough 32, the rear side and left and right ends of the first middle foam material 44 are abutted against the rear portion 324 of the positioning trough 32, which completes the positioning of the first middle foam material 44. Then, a force is applied to downwardly press the first middle foam material 44 to stick the bottom surface of the first middle foam material 44 on the top surface of the first composite material 42 positively. After that, the second middle foam material 46 is put into the positioning trough 32, as the step S5 shown in FIG. 4B. Because the contour of the front portion 322 of the positioning trough 32 corresponds in coordination with the contour of the second middle foam material 46, after the second middle foam material 46 is put into the positioning trough 32, the front side and left and right ends of the second middle foam material 46 are abutted against the front portion 322 of the positioning trough 32, which completes the positioning of the second middle foam material 46. Then, a force is applied to downwardly press the second middle foam material 46 to stick the bottom surface of the second middle foam material 46 on the top surface of the first composite material 42 and the top surface of the first middle foam material 44 positively. Further, after the second middle foam material 46 is put into the positioning trough 32, the third positioning indentations 47 of the second middle foam material 46 are engaged with the second positioning protrusions 38 of the pressing plate 30 respectively, which completes the positioning of the second middle foam material 46.

e) The pressing plate 30 is opened to the open position P1 and the second composite material 48 is put into the accommodating recess 24 of the base 20 in a way that the bottom surface of the second composite material 48 is sticked on the top surface of the middle foam material, so that a multilayer composite material 40 is obtained.

In this step, a force is firstly applied to pull the protruding rod 34 to open the pressing plate 30 to the open position P1. Then, the second composite material 48 is put into the accommodating recess 24 of the base 20 in a way that the bottom surface (the side applied with glue) of the second composite material 48 faces downward, as the step S6 shown in FIG. 4B, causing the bottom surface of the second composite material 48 sticked on the top surface of the second middle foam material 46, so that a multilayer composite material 40 is obtained. Because the second composite material 48 is cut with the specific shape corresponding to the contour of the accommodating recess 24 in advance, the second composite material 48 will not be squeezed and deformed after being put into the accommodating recess 24. Further, after the second composite material 48 is put into the accommodating recess 24, the second positioning indentations 49 of the second composite material 48 are engaged with the first positioning protrusions 26 of the base 20 respectively, which completes the positioning of the second composite material 48.

f) As the step S7 shown in FIG. 4B, the multilayer composite material 40 is taken out from the accommodating recess 24 of the base 20 and sent into an oven to be dried, so as to solidify the glue for benefiting the subsequent processing.

In conclusion, the laminating auxiliary jig 10 of the present invention uses the simple structural combination of the base 20 and the pressing plate 30 to help the user quickly complete laminating the multilayer composite material 40, so as to improve processing efficiency.

What is claimed is:

1. A laminating auxiliary jig for a multilayer composite material, the laminating auxiliary jig comprising:
a base having a top surface and an accommodating recess provided on the top surface; and
a pressing plate having a positioning trough penetrating through top and bottom surfaces of the pressing plate, a rear side of the pressing plate being pivotably attached to the top surface of the base so that the pressing plate is pivotable relative to the base between an open position and a close position, the pressing plate being separated from the accommodating recess of the base when the pressing plate is located at the open position, the pressing plate being located in the accommodating recess of the base and the positioning trough of the pressing plate communicating with the accommodating recess of the base when the pressing plate is located at the close position.

2. The laminating auxiliary jig as claimed in claim 1, wherein a contour of the accommodating recess corresponds in coordination with a contour of the pressing plate.

3. The laminating auxiliary jig as claimed in claim 1, further comprising a protruding rod, the protruding rod being provided adjacent to a front side of the pressing plate and an end of the protruding rod being fixed to the top surface of the pressing plate.

4. The laminating auxiliary jig as claimed in claim 1, wherein the base further has a first positioning protrusion provided on an inner periphery of the accommodating recess.

5. The laminating auxiliary jig as claimed in claim 1, wherein the pressing plate further has a second positioning protrusion provided on an inner periphery of the positioning trough.

6. A method of using the laminating auxiliary jig as claimed in claim 1, the method comprising the steps of:
a) applying glue to a top surface of a first composite material, top and bottom surfaces of a middle foam material and a bottom surface of a second composite material;
b) opening the pressing plate to the open position and putting the first composite material into the accommodating recess of the base in a way that the top surface of the first composite material faces upward;
c) closing the pressing plate to the close position to press the pressing plate on a rim of the first composite material;
d) putting the middle foam material into the positioning trough of the pressing plate to stick the bottom surface of the middle foam material on the top surface of the first composite material;
e) opening the pressing plate to the open position and putting the second composite material into the accommodating recess of the base to stick the bottom surface of the second composite material on the top surface of the middle foam material, thereby obtaining a multilayer composite material; and
f) taking out the multilayer composite material from the accommodating recess of the base.

7. The method as claimed in claim 6, wherein in the step a), top and bottom surfaces of a first middle foam material and top and bottom surfaces of a second middle foam material are applied with glue; in the step d), the first middle foam material is firstly put into the positioning trough of the pressing plate in a way that the bottom surface of the first middle foam material is sticked on the top surface of the first composite material, and then the second middle foam material is put into the positioning trough of the pressing plate in a way that the bottom surface of the second middle foam material is sticked on the top surface of the first composite material and the top surface of the first middle foam material; in the step e), the bottom surface of the second composite material is sticked on the top surface of the second middle foam material.

8. The method as claimed in claim 7, wherein in the step d), a rear side and left and right ends of the first middle foam material are abutted against a rear portion of the positioning trough, and a front side and left and right ends of the second middle foam material are abutted against a front portion of the positioning trough.

9. The method as claimed in claim 7, wherein the pressing plate further has a second positioning protrusion provided on an inner periphery of the positioning trough; an outer periphery of the second middle foam material has a third positioning indentation; in the step d), the third positioning indentation of the second middle foam material is engaged with the second positioning protrusion of the pressing plate.

10. The method as claimed in claim 6, wherein a contour of the accommodating recess corresponds in coordination with a contour of the pressing plate.

11. The method as claimed in claim 6, wherein the laminating auxiliary jig further comprises a protruding rod; the protruding rod is provided adjacent to a front side of the pressing plate and an end of the protruding rod is fixed to the top surface of the pressing plate; in the step b) and the step e), the protruding rod is pulled to open the pressing plate from the close position to the open position.

12. The method as claimed in claim 6, wherein the base further has a first positioning protrusion provided on an inner periphery of the accommodating recess; an outer periphery of the first composite material has a first positioning indentation; an outer periphery of the second composite material has a second positioning indentation; in the step b), the first positioning indentation of the first composite material is engaged with the first positioning protrusion of the base; in the step f), the second positioning indentation of the second composite material is engaged with the first positioning protrusion of the base.
